(19) United States
(12) Patent Application Publication
(10) Pub. No.: US 2026/0320492 A1
(43) Pub. Date: Oct. 15, 2026

(54) GEOLOGICAL MARKER PREDICTION WITH FEATURE ENGINEERING

(71) Applicant: Schlumberger Technology Corporation, Sugar Land, TX (US)

(72) Inventors: Shashin Sharan, Houston, TX (US); Kaustubh Shrivastava, Houston, TX (US); Per Irgens, Houston, TX (US)

(21) Appl. No.: 19/644,544

(22) Filed: Apr. 10, 2026

Related U.S. Application Data
(60) Provisional application No. 63/787,034, filed on Apr. 11, 2025.

(51) Int. Cl. G06N 20/00

(52) U.S. Cl. CPC G06N 20/00

(57) ABSTRACT

A method for predicting geological markers in a subsurface includes receiving first input data related to a subsurface. The method also includes extracting statistical features from the first input data. The method also includes training a machine-learning (ML) model using the statistical features to produce a trained ML model. The ML model is trained to predict first geological markers in the first input data. The method also includes receiving second input data. The method also includes predicting second geological markers in the second input data using the trained ML model.

### CROSS-REFERENCE TO RELATED APPLICATIONS

This application claims priority to U.S. Provisional Patent Application No. 63/787,034, filed on Apr. 11, 2025, which is incorporated by reference.

### BACKGROUND

Geological markers are indicators of changes in geology and petrophysical properties, playing a role in the identification of pay zones and the estimation of oil and gas volumes. Accurate identification of these markers is helpful for understanding subsurface conditions. Conventional methods for detecting geological markers are time-consuming, which delays decision-making and can lead to inefficiencies in resource estimation and management. Therefore, what is needed is an improved system and method for predicting geological markers.

### SUMMARY

A method for predicting geological markers in a subsurface is disclosed. The method includes receiving first input data related to a subsurface. The method also includes extracting statistical features from the first input data. The method also includes training a machine-learning (ML) model using the statistical features to produce a trained ML model. The ML model is trained to predict first geological markers in the first input data. The method also includes receiving second input data. The method also includes predicting second geological markers in the second input data using the trained ML model.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for predicting geological markers in a subsurface, according to an embodiment.

FIG. 3 illustrates a schematic view of a marker prediction training block, according to an embodiment.

FIG. 4 illustrates a schematic view showing marker prediction validation and evaluation, according to an embodiment.

FIG. 5 illustrates a gamma ray log along with comparison of marker location predicted for a well using the proposed method with window sizes of 5, 15, and 25, according to an embodiment.

FIG. 6 illustrates another gamma ray log along with comparison of marker location predicted for another well using the proposed method with window sizes of 5, 15, and 25, according to an embodiment.

FIG. 7 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

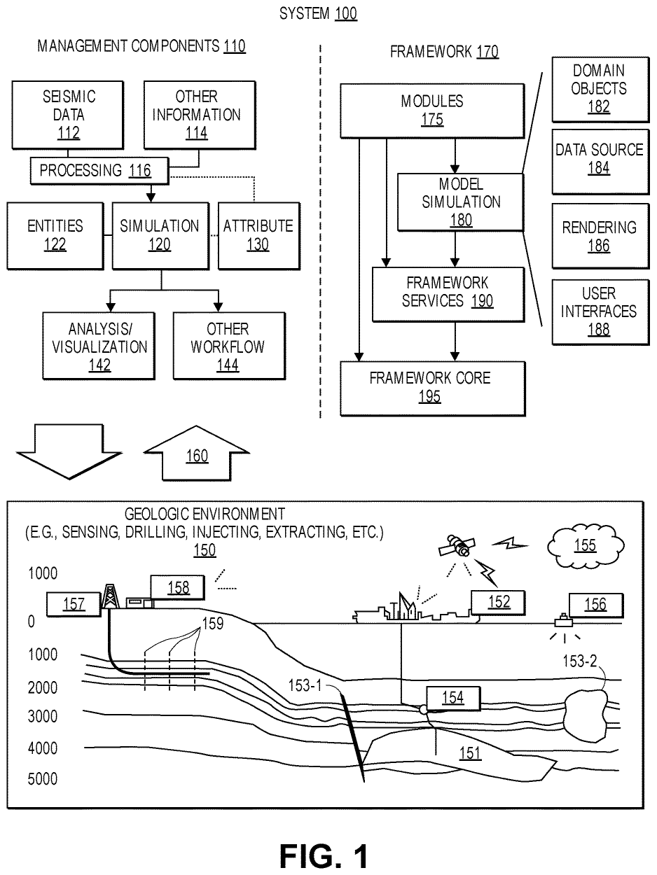

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY software (SLB, Houston, Texas). More particularly, SYMMETRY may process workflows in a single integrated environment with accurate thermodynamic fluid representation and consistent modeling across multiple disciplines including process, production, and HSE. The simulator integrates steady-state and transient (e.g., dynamic) analyses that can be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM (SLB, Houston, Texas). More particularly, PIPESIM is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Geological Marker Prediction with Feature Engineering

The method described herein applies a time series-based feature extractor tool designed to expedite the identification of marker horizons across different wells in a region. By leveraging advanced algorithms and real-time data analysis, the method enhances the speed and accuracy of marker predictions, providing reliable geological forecasts much faster than conventional methods. The method improves the identification of geological markers and supports more timely and efficient decision-making in the oil and gas industry, ultimately contributing to more streamlined and cost-effective operations.

The method uses feature engineering to create additional features that enhance the prediction of geological markers. In an example, a time-series feature extraction based on scalable hypothesis tests (i.e., tsfresh) tool may be developed for extracting numerous statistical features from time series data, aiding various machine learning tasks such as regression and classification. The method leverages the capabilities of tsfresh to extract statistical features from well logs, going beyond conventional time-series applications. These extracted features make the prediction of markers feasible using machine learning, a task that is otherwise challenging due to the highly sparse nature of marker data in well logs.

The method may handle large amounts of well log data, as well as different types of marker tops and solution deployment issues. The method may provide adaptability to different fields, and ease of deployment because of less dependencies on complex tools and libraries. The method may provide faster turnaround time, so that efficiency, domain experts can focus on interpretation.

### Exemplary Method

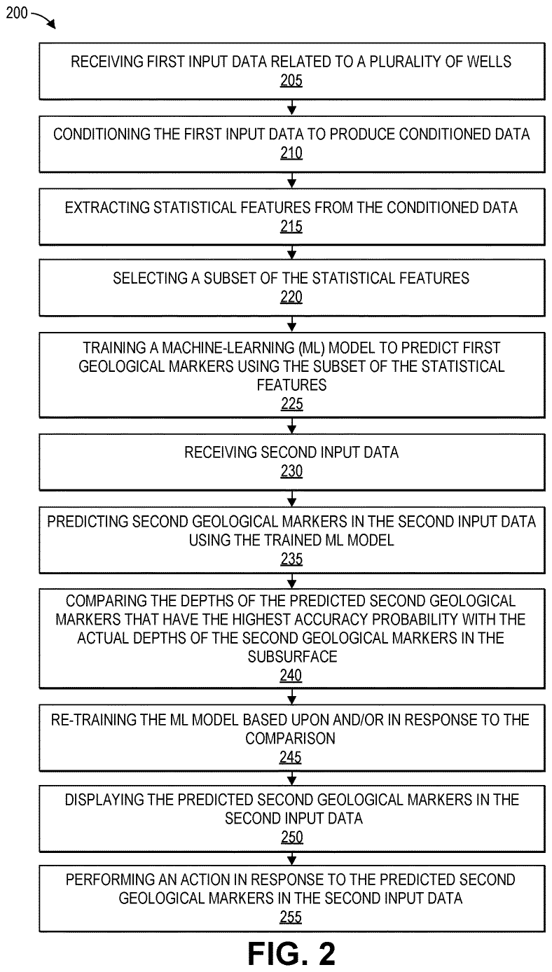

FIG. 2 illustrates a flowchart of a method 200 for predicting geological markers in a subsurface, according to an embodiment. The method 200 is less computationally-expensive compared to conventional methods, which use GPUs or other intensive computing resources. An illustrative order of the method 200 is provided below; however, one or more portions of the method 200 may be performed in a different order, simultaneously, repeated, or omitted. At least a portion of the method 200 may be performed using a computing system.

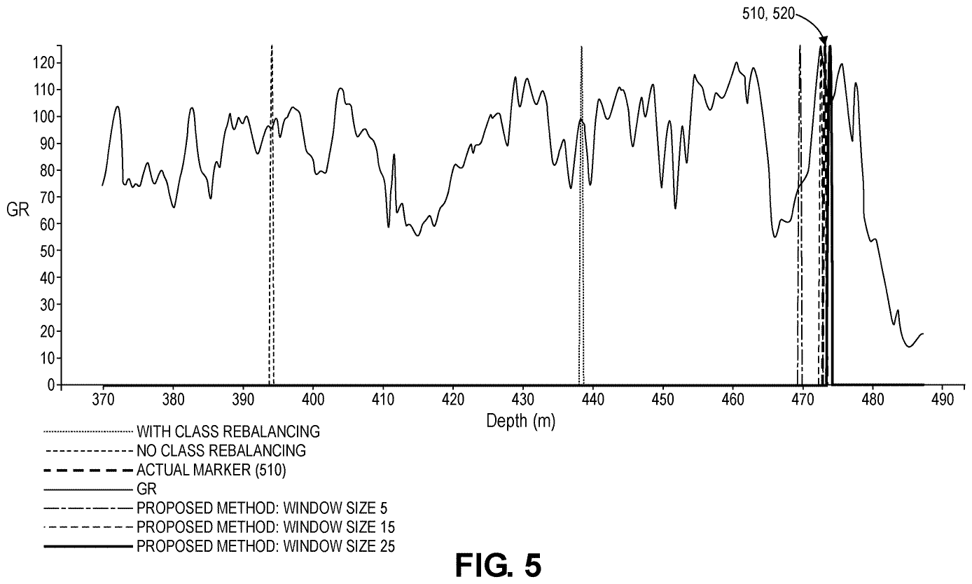

The method 200 may include receiving first input data related to a plurality of wells, as at 205. The first data may be training data. The first input data may be real (e.g., measured) or synthetic data. The first input data may include first well log data, first mud log data, and/or a first gas curve. An example of the first input data (e.g., gamma ray data) may be seen in FIGS. 5 and/or 6, which are described in greater detail below.

The method 200 may also include conditioning the first input data to produce conditioned data, as at 210. Conditioning the first input data may include reorganizing the first input data to produce reorganized data. The first input data may be reorganized to mimic time-series data based on depth for each of the wells. Conditioning the first input data may also or instead include segmenting the reorganized data to produce segmented data. The segmented data may include rolling windows at different intervals along the depth. Each of the rolling windows has a size from 1 sample to 10 samples, from 10 samples to 20 samples, or from 20 samples to 30 samples. The rolling window size can be greater than 30 and may be subject to testing.

The method 200 may also include extracting statistical features from the conditioned data, as at 215. The statistical features may be extracted from each rolling window within the segmented data. The statistical features may capture underlying patterns and/or characteristics of the first input data. The statistical features may be or include a mean, a median, a kurtosis, and/or a transformation. The statistical features may be extracted using time-series feature extraction based on scalable hypothesis tests (e.g., Tsfresh).

The method 200 may also include selecting a subset of the statistical features, as at 220. The subset of the statistical features may have a correlation that is above a threshold (e.g., 75%) with target marker horizons.

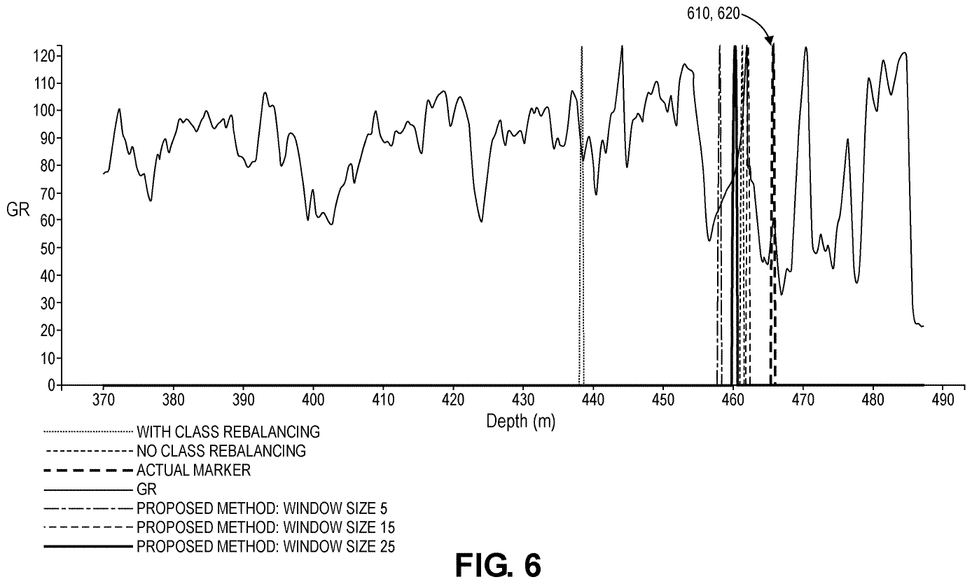

The method 200 may also include training a machine-learning (ML) model using the subset of the statistical features to produce a trained ML model, as at 225. The ML model may be trained to predict (e.g., first) geological markers. Predicting the first geological markers may include predicting the depths of the first geological markers in the subsurface. The first geological markers may include marker tops and/or marker horizons. An example of the first geological marker may be seen at reference number 510 in FIGS. 5 and/or 610 in FIG. 6.

The method 200 may also include receiving second input data, as at 230. The second input data may include second well log data, second mud log data, and/or a second gas curve. The second input data may be real (e.g., measured) data. In an embodiment, the first input data may be a first portion of measured data, and the second input data may be a second portion of the measured data. In another embodiment, the first input data may be a first set of measured data, and the second input data may be a second set of measured data, where the second set is measured at a different time and/or in a different location (e.g., a second plurality of wells). An example of the second input data (e.g., gamma ray data) may be seen in FIGS. 5 and/or 6, which are described in greater detail below.

The method 200 may also include predicting (e.g., second) geological markers using the trained ML model based upon the second input data, as at 235. Predicting the second geological markers may include predicting the depths of the second geological markers in the subsurface. Predicting the depths of the second geological markers may include predicting a plurality of depths for each of the second geological markers. The depths for each of the second geological markers has a corresponding accuracy probability (e.g., 85%). An example of the second geological marker may be seen at reference number 520 in FIGS. 5 and/or 620 in FIG. 6.

The method 200 may also include comparing the depths of the predicted second geological markers that have the highest accuracy probability with the actual (e.g., known or measured) depths of the second geological markers in the subsurface, as at 240.

The method 200 may also include re-training (e.g., calibrating) the ML model based upon and/or in response to the comparison, as at 245.

The method 200 may also include displaying the predicted second geological markers in the second input data, as at 250. As mentioned above, an example of this may be seen in FIGS. 5 and/or 6.

The method 200 may also include performing an action in response to the predicted second geological markers in the second input data, as at 255. The action may include selecting more input features generated by Tsfresh. The action may also or instead include fine-tuning the window size to improve the accuracy of model. In another embodiment, the action may be or include generating and/or transmitting a signal that recommends, instructs, or causes a physical action to occur. In another embodiment, the action may include performing the physical action. For example, the physical action may include varying a trajectory of a well (e.g., steering a downhole tool using a rotary steerable system) toward a hydrocarbon reservoir in response to the second geological markers indicating a location and/or size of the hydrocarbon reservoir. In another embodiment, the physical action may include varying the trajectory of the well away from a hazard or reducing a weight on a drill bit in response to the second geological markers indicating a hazard in the current drill trajectory.

### Machine-Learning Driven Prediction of Geological Marker Signatures

The method described above may enhance the accuracy and efficiency of predicting geological markers from well logs, which are helpful for subsurface analysis and resource estimation in the oil and gas industry. The method uses advanced algorithms that leverage machine learning (ML) techniques to predict the depths of geological formations. The scope includes the integration of feature engineering, time series analysis, and ML to process available well and mud log data, extraction of statistical features, and training models for precise predictions. The approach ensures computational efficiency and ease of deployment, addressing the limitations of conventional methods to provide a reliable and scalable solution for geological marker prediction.

The method involves transforming various types of well logs, mud logs, or both. The algorithm works with one or multiple of these logs, which are then conditioned to resemble time series data. This data is then processed to extract numerous statistical features. These features serve as input variables for ML models designed to predict markers. The procedure involves three steps: data conditioning, feature extraction, and model training. Initially, log data is preprocessed to mimic time series data. Next, the conditioned data is fed into time series analysis to generate statistical features. Finally, these features are used to train ML models. This approach ensures computational simplicity and ease of deployment, overcoming the challenges associated with conventional methods.

Implementing the method led to substantial improvements in the accuracy and efficiency of marker predictions. On a publicly available dataset, the method predicted markers within a range of 3 m. The results show that the method reduces computational cost and simplifies deployment compared to conventional methods. Observations indicate that the extracted statistical features effectively capture the patterns used for accurate marker prediction. Thus, the method provides a robust and scalable solution, enhancing the reliability of geological forecasting and supporting more informed decision making in subsurface analysis.

Conventionally, marker picking has been a manual, tedious, and error-prone task, which may affect reservoir models and interpretations. This problem becomes even more pronounced with the high number of wells in U.S. land unconventional fields. The method aims to reduce the manual effort involved in marker picking, allowing geologists to focus more on interpretation. The method employs an innovative use of feature extraction from various well logs and mud logs, which are not conventionally treated as time series data, and combining this with machine learning models. This method is both computationally efficient and easy to deploy, addressing the limitations of traditional techniques and providing a scalable solution for unconventional oil and gas exploration.

In the energy industry where machine learning (ML) applications have been rigorously studied and diversely applied to automate a wide range of tedious and repetitive tasks, there remains an elusive white whale—computationally efficient and accurate prediction of well top markers. Picking well top markers may be used to identify the reservoir properties of a prospective area and thus identify the drilling targets. In this workflow, a geoscientist may study the various log measurements of independent wells such as Gamma Ray (GR) logs, Density Porosity (PHID) logs, Neutron Porosity (PHIN) logs, and Deep Resistivity (RESD) logs, and others depending on the data availability. These well logs present a detailed plot of parameters versus depth, enabling geoscientists to distinguish various rock formations by analyzing the variations in parameters and rock properties.

The geologist may flag each formation boundary with a well top marker or well-top. In this way, target formations, seals, and other elements of the petroleum system are identified in each well, forming the foundation of both 2D maps and 3D models of the reservoir. However, the effort used to pick markers across a field is substantial. The large number of formations and wells in unconventional plays increases the time involved, while structural complexity, minor variations in log response, differing types of logs available for each well, and previous (sometimes conflicting) picks by other geologists all add to the complications of this essential workflow.

Given the vast amount of data involved, a machine learning based approach is positioned to address these challenges and rapidly accelerate the time required to pick a full set of markers across a prospect. To enhance the computational efficiency and accuracy of ML for well marker prediction, the method preprocesses log data to resemble time-series data. The conditioned data may then be utilized in a time-series analysis to generate statistical features for training ML models without substantial computational resources. The proposed time-series methodology is agnostic to log type, and it also enhances feature engineering to refine predictions and improve accuracy. Also, the proposed method does not involve the selection of basement markers.

The method is designed to predict marker horizons in well logs using machine learning techniques. The procedure is divided into two phases: training and testing. Each phase is structured to ensure optimal performance and accuracy of the predictive model.

### Phase 1: Training

The first step in the training phase involves splitting the data into training and testing sets based on individual wells. This ensures that the model is evaluated on data it has not encountered during training, thereby promoting robust performance.

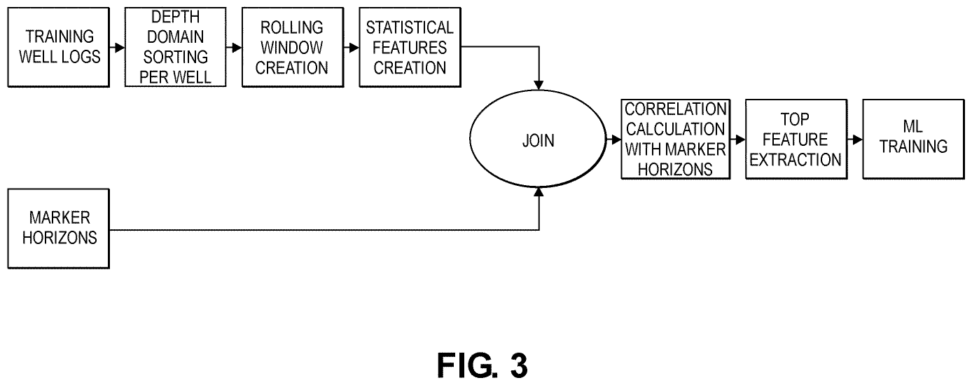

FIG. 3 illustrates a schematic view of a marker prediction training block, according to an embodiment. The training process may include data reorganization. More particularly, the well logs are reorganized to mimic time series data by sorting the available data based on depth for each well. This ensures that the data points are temporally consistent. The training process may also include rolling window creation. More particularly, a rolling window is created along the depth for each well. This involves segmenting the data into windows at each depth interval. These windows serve as the basis for feature extraction. The training process may also include feature extraction. More particularly, various statistical features (e.g., mean, median, kurtosis, etc.) are extracted from the data within each rolling window. These features capture the underlying patterns and characteristics of the well logs that are relevant for training the machine learning model. The training process may also include feature selection. More particularly, for computational efficiency, the top features that are highly correlated with the target marker horizons are selected. This reduces the dimensionality of the data while retaining the most informative features for model training.

The selected features are then used to train the machine learning model. Given the highly imbalanced nature of the dataset, with relatively few marker horizons present, the F1 score is used during the training phase to assess the model's performance. The F1 score provides a balance between precision and recall, making it suitable for imbalanced datasets.

### Phase 2: Testing

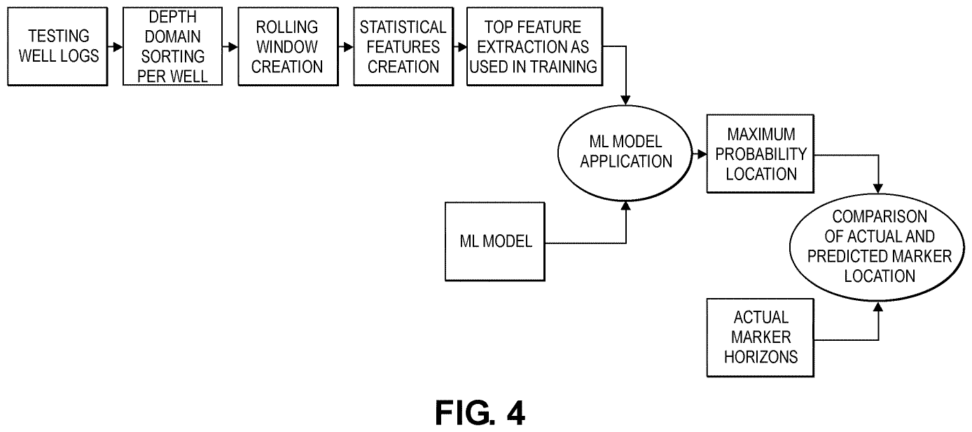

FIG. 4 illustrates a schematic view showing marker prediction validation and evaluation, according to an embodiment. The testing phase follows a similar procedure to ensure consistency and comparability. The testing phase may include rolling window application. More particularly, the same size of rolling window used in the training phase is applied to the testing data. This ensures that the model is evaluated under the same conditions as it was trained. The testing phase may also include feature calculation. More particularly, the same statistical features are calculated for the testing data as were for the training data. This step ensures that the testing data is represented in a similar feature space. The testing phase may also include feature extraction. More particularly, relevant features are extracted from the testing data, mirroring the feature selection process performed during training.

The trained machine learning model is then applied to the testing data to evaluate its performance. Considering the highly imbalanced nature of the data, the method may include post-processing to extract the location of predicted marker horizons. This post-processing involves extracting the depth corresponding to the maximum probability of the ML model prediction.

### Model Evaluation

To evaluate the model's performance, the predicted location of the marker horizon is compared with the actual location of the marker horizon, as illustrated in FIG. 4. Rather than relying on the F1 score, which may not adequately capture the accuracy due to the highly imbalanced nature of the data, the method may use the depth corresponding to the maximum probability of the ML model prediction. This approach allows the method to identify the most likely marker horizon locations predicted by the model. The smaller the distance between the predicted and actual marker horizon locations, the better the model's performance. This method ensures computational simplicity and ease of deployment, effectively addressing the challenges associated with traditional approaches.

### Results

The data set includes various well logs. For this analysis, a total of seven well logs were used: five for training the machine learning model and two for validation purposes. The well logs employed to develop the machine learning model included Gamma Ray (GR) logs, Density Porosity (PHID) logs, Neutron Porosity (PHIN) logs, and Deep Resistivity (RESD) logs. The logs were recorded at every 0.25 m depth interval.

To evaluate the effectiveness of our proposed method, it was compared with two other approaches:
Method 1: In this method, no feature engineering is applied. The available logs are used directly as input, and the marker horizon location serves as the target for training and validating the machine learning model. However, this approach faces challenges due to the highly imbalanced nature of the target data, with less than 1% of the data containing the target marker horizon.
Method 2: Adding to previous method, data rebalancing is applied to prevent issues such as model bias before training the machine learning model.

FIG. 5 illustrates a gamma ray log along with comparison of marker location predicted for a well using the proposed method with window sizes of 5, 15, and 25, compared to Method 1 and Method 2, according to an embodiment. To better understand the effect of different rolling window sizes in the proposed method, three different experiments were conducted with rolling window sizes of 5, 15, and 25 samples. As shown, one of the wells demonstrates that with a window size of 15, the proposed method may predict the closest location of the marker within a proximity of 0.5 m. In contrast, a window size of 25 yields a marker location with a proximity of 0.7 m. It is evident from the figure that using well logs directly, both with and without class rebalancing, results in predicted marker horizons that are off from the actual marker location, with discrepancies of approximately 35 m and 80 m, respectively. Clearly, the proposed method stands out in terms of predicting the location of markers accurately.

FIG. 6 illustrates a gamma ray log along with comparison of marker location predicted for another well using the proposed method with window sizes of 5, 15, and 25, compared to Method 1 and Method 2, according to an embodiment. It is observed that a window size of 15 consistently provides close predictions, with a proximity of 3.5 m. In contrast, the prediction using well logs without any rebalancing results in a location that is far from the actual marker location. Although class rebalancing improves the prediction, bringing it within 3.2 m of the actual marker location, it does not consistently achieve the accuracy of the proposed method. The results indicate that while class rebalancing may sometimes yield closer predictions compared to the method without rebalancing, it lacks the reliability of the proposed method, which consistently delivers closer predictions with a rolling window size of 15.

In summary, the proposed method with a window size of 15 stands out in terms of the closeness of the predicted marker location to the actual marker location for both wells. Table 1 below summarizes the results for both wells using our proposed method and the other two methods.

TABLE 1

| | | | Proposed | Proposed | Proposed |
|---|---|---|---|---|---|
| | | | method w/ | method w/ | method w/ |
| | | | window | window | window |
| Well | Method 1 | Method 2 | size 5 | size 15 | size 25 |
| 00/10-10- | 79 | 34.8 | 3.5 | 0.5 | 0.7 |
| 069-18W4/0 | | | | | |
| 00/06-31- | 4.2 | 3.2 | 7.5 | 3.5 | 5.2 |
| 068-18W4/0 | | | | | |

The results obtained from the experiments highlight the effectiveness of the proposed method in predicting marker horizons in well logs. By leveraging feature engineering and rolling windows, the proposed method outperforms the conventional methods in terms of accuracy and proximity to the actual marker locations.

In the first set of experiments, it was observed that a rolling window size of 15 m provided the closest predictions, with a proximity of 0.5 m to the actual marker location in one well and 3.5 m in another. This suggests that a rolling window size of 15 m strikes a balance between capturing sufficient data for feature extraction and maintaining the resolution for accurate predictions. Comparatively, using the well logs directly without any feature engineering resulted in predictions that were off from the actual marker locations, highlighting the challenges posed by the highly imbalanced nature of the dataset. The results indicate that while class rebalancing may sometimes yield closer predictions compared to the method without rebalancing, it does not consistently achieve the accuracy of the proposed method.

The success of the proposed method may be attributed to several factors. First, reorganizing the well logs to mimic time series data and creating rolling windows allows for the extraction of meaningful statistical features that are useful for training the machine learning model. Second, selecting features that are highly correlated with the target marker horizons ensures computational efficiency and enhances the model's predictive power. Finally, the post-processing step, which involves extracting the depth corresponding to the maximum probability of the ML model prediction, provides a practical and effective way to determine the marker locations.

Overall, the proposed method demonstrates that feature engineering and careful selection of rolling window sizes improves the accuracy of marker horizon predictions. The comparison with other methods underscores the addressing data imbalances and highlights the limitations of approaches that do not incorporate feature engineering.

In conclusion, the proposed method for predicting marker horizons in well logs improves accuracy and reliability over conventional approaches. By reorganizing well logs to mimic time series data, creating rolling windows, and extracting relevant statistical features, the proposed method consistently provided the closest predictions to actual marker locations, especially with a rolling window size of 15. Compared to methods that use well logs directly or incorporate data rebalancing, the proposed method stands out in terms of both proximity to actual marker locations and consistency. The comprehensive feature extraction process and practical post-processing step ensure computational efficiency and enhance the model's predictive power, making the proposed method a robust and efficient solution for marker prediction in geological studies.

### Exemplary Computing System

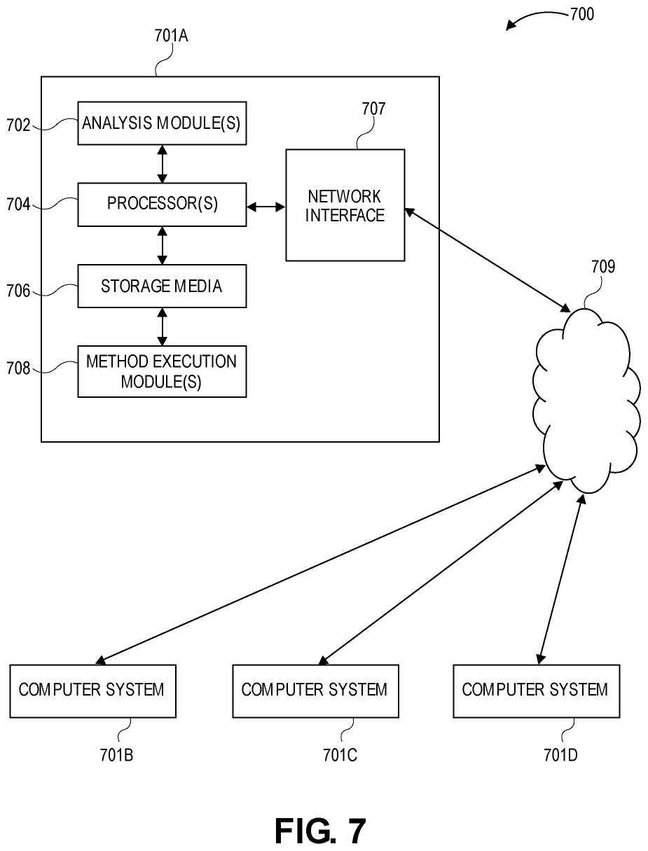

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more method execution module(s) 708. In the example of computing system 700, computer system 701A includes the method execution module 708. In some embodiments, a single method execution module may be used to perform some aspects of one or more embodiments of the methods disclosed herein. In other embodiments, a plurality of method execution modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for predicting geological markers in a subsurface, the method comprising:
receiving first input data related to a subsurface;
extracting statistical features from the first input data;
training a machine-learning (ML) model using the statistical features to produce a trained ML model, wherein the ML model is trained to predict first geological markers in the first input data;
receiving second input data; and
predicting second geological markers in the second input data using the trained ML model.

2. The method of claim 1, wherein the first input data comprises first well log data, first mud log data, and a first gas curve.

3. The method of claim 1, further comprising conditioning the first input data to produce conditioned data, wherein the statistical features are extracted from the conditioned data.

4. The method of claim 3, wherein conditioning the first input data comprises reorganizing the first input data to produce reorganized data, and wherein the first input data is reorganized to mimic time-series data based on depth for each of a plurality of wells.

5. The method of claim 4, wherein conditioning the first input data further comprises segmenting the reorganized data to produce segmented data, wherein the segmented data comprises rolling windows at different intervals along the depth, and wherein each of the rolling windows has a size from 1 sample to 30 samples.

6. The method of claim 5, wherein the statistical features are extracted from each rolling window within the segmented data.

7. The method of claim 1, wherein the statistical features capture underlying patterns and/or characteristics of the first input data, wherein the statistical features comprise a mean, a median, a kurtosis, and/or a transformation, and wherein the statistical features are extracted using time-series feature extraction based on scalable hypothesis tests.

8. The method of claim 1, further comprising selecting a subset of the statistical features, wherein the subset of the statistical features has a correlation that is above a threshold with target marker horizons, and wherein the ML model is trained using the subset of the statistical features.

9. The method of claim 1, further comprising displaying the second geological markers in the second input data.

10. The method of claim 1, further comprising performing a physical action based upon and/or in response to the second geological markers.

11. A computing system, comprising:
one or more processors; and
a memory system comprising one or more non-transitory computer-readable media storing instructions that, when executed by at least one of the one or more processors, cause the computing system to perform operations, the operations comprising:
receiving first input data related to a subsurface;
extracting statistical features from the first input data;
training a machine-learning (ML) model using the statistical features to produce a trained ML model, wherein the ML model is trained to predict first geological markers in the first input data;
receiving second input data; and
predicting second geological markers in the second input data using the trained ML model.

12. The computing system of claim 11, wherein the first and/or second geological markers comprise marker tops and/or marker horizons in the subsurface.

13. The computing system of claim 11, wherein predicting the first geological markers comprises predicting depths of the first geological markers in the subsurface, and wherein predicting the second geological markers comprises predicting depths of the second geological markers in the subsurface.

14. The computing system of claim 13, wherein predicting the depths of the second geological markers comprises predicting a plurality of depths for each of the second geological markers.

15. The computing system of claim 14, wherein the depths for each of the second geological markers has a corresponding accuracy probability.

16. A non-transitory computer-readable medium storing instructions that, when executed by one or more processors of a computing system, cause the computing system to perform operations, the operations comprising:
receiving first input data related to a subsurface;
extracting statistical features from the first input data;
training a machine-learning (ML) model using the statistical features to produce a trained ML model, wherein the ML model is trained to predict first geological markers in the first input data;
receiving second input data; and
predicting second geological markers in the second input data using the trained ML model.

17. The non-transitory computer-readable medium of claim 16, wherein the operations further comprise:
comparing depths of the predicted second geological markers that have a highest accuracy probability with actual depths of the second geological markers in the subsurface; and
re-training the ML model based upon and/or in response to the comparison.

18. The non-transitory computer-readable medium of claim 16, wherein the operations further comprise performing an action in response to the second geological markers in the second input data, wherein the action comprises generating and/or transmitting a signal that recommends, instructs, or causes a physical action to occur.

19. The non-transitory computer-readable medium of claim 18, wherein the physical action comprises varying a trajectory of a well toward a hydrocarbon reservoir in the subsurface in response to the second geological markers indicating a location and/or size of the hydrocarbon reservoir.

20. The non-transitory computer-readable medium of claim 18, wherein the physical action comprises varying a trajectory of a well away from a hazard or reducing a weight on a drill bit in response to the second geological markers indicating the hazard in a current trajectory.
